(19) United States
(12) Patent Application Publication
(10) Pub. No.: US 2017/0321105 A1
(43) Pub. Date: Nov. 9, 2017

(54) Weighted Composition for Treatment of a Subterranean Formation

(71) Applicant: Halliburton Energy Services, Inc., Houston, TX (US)

(72) Inventors: Cato Russell McDaniel, The Woodlands, TX (US); Dale E. Jamison, Humble, TX (US); Timothy N. Harvey, Humble, TX (US); Xiangnan Ye, Cypress, TX (US)

(73) Assignee: Halliburton Energy Services, Inc., Houston, TX (US)

(21) Appl. No.: 15/522,712

(22) PCT Filed: Dec. 17, 2014
(86) PCT No.: PCT/US2014/070811

§ 371 Date: Apr. 27, 2017

(51) Int. Cl. C09K 8/48; C04B 20/10; C09K 8/03; C09K 8/80; C09K 8/528; C04B 28/02

(52) U.S. Cl. CPC C09K 8/48; C09K 8/528; C04B 20/107; C04B 28/02; C09K 8/805; C04B 20/1066; C09K 8/032; C09K 2208/02; C09K 2208/08; C09K 2208/26

(57) ABSTRACT

Various embodiments disclosed relate to a weighted composition for treatment of a subterranean formation. In various embodiments, the present invention provides a method of treating a subterranean formation. The method can include placing in a subterranean formation a weighted composition. The weighted composition can include a weighting agent and an inorganic coating material on the weighting agent. The inorganic coating material can be a crystalline inorganic coating material. The inorganic coating material can be an amorphous inorganic coating material.

### BACKGROUND

Weighting materials may be used in a variety of subterranean operations. For example, weighting materials may be used in drilling fluids during subterranean operations to increase the density of the drilling fluid. Despite their wide use, weighting materials can be abrasive and can thus negatively impact the subterranean operations in which they are employed. Further, the settling and sagging of weighting materials may lead to safety and operational problems, particularly in inclined boreholes.

### BRIEF DESCRIPTION OF THE FIGURES

The drawings illustrate generally, by way of example, but not by way of limitation, various embodiments discussed in the present document.

FIG. 1 illustrates a drilling assembly, in accordance with various embodiments.

FIG. 2 illustrates a system or apparatus for delivering a weighted composition to a subterranean formation, in accordance with various embodiments.

FIGS. 3A and 3B illustrate a scanning electron microscopy (SEM) image of calcium carbonate coated iron oxide particles at 150 times magnification and 6,500 times magnification, respectively, in accordance with various embodiments.

FIGS. 4A and 4B illustrate a SEM image of barite coated iron oxide particles, at 500 times magnification and 1,500 times magnification, respectively, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.”

In the methods of manufacturing described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Non-limiting examples of solvents are silicones, organic compounds, water, alcohols, ionic liquids, and supercritical fluids.

The term “room temperature” as used herein refers to a temperature of about 15° C. to 28° C.

As used herein, the term “polymer” refers to a molecule having at least one repeating unit and can include copolymers.

The term “copolymer” as used herein refers to a polymer that includes at least two different repeating units. A copolymer can include any suitable number of repeating units.

As used herein, the term “iron oxide” refers to a compound that includes iron and oxygen (e.g., FeO, Fe₃O, Fe₄O₅, Fe₂O₃).

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packer fluid” refers to fluids or slurries that can be placed in the annular region of a well between tubing and outer casing above a packer. In various examples, the packer fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

As used herein, a “carrier fluid” refers to any suitable fluid for suspending, dissolving, mixing, or emulsifying with one or more materials to form a composition. For example, the carrier fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt. % to about 99.999 wt. % of a composition, or a mixture including the same, or about 0.001 wt. % or less, 0.01 wt. %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt. % or more.

In various embodiments, the present invention provides a method of treating a subterranean formation. The method includes placing in a subterranean formation a weighted composition. In various embodiments, the weighted composition includes a coated weighting agent. The coated weighting agent includes a weighting agent and an inorganic coating material on the weighting agent. The inorganic coating material is a crystalline inorganic coating material. Alternatively, the inorganic coating material is an amorphous inorganic coating material.

In various embodiments, the present invention provides a method of treating a subterranean formation with a weighted composition that includes placing in a subterranean formation the weighted composition that includes a coated weighting agent that includes iron oxide and a crystalline inorganic coating material on the iron oxide, wherein the crystalline inorganic coating material is chosen from barium sulfate, calcium carbonate, and combinations thereof.

In various embodiments, the present invention provides a system that includes a weighted composition. The weighted composition includes a coated weighting agent. The coated weighting agent includes a weighting agent and an inorganic coating material on the weighting agent. The system also includes a subterranean formation including the weighted composition therein.

In various embodiments, the present invention provides a weighted composition for the treatment of a subterranean formation. The weighted composition includes a coated weighting agent. The coated weighting agent includes a weighting agent and an inorganic coating material on the weighting agent.

In various embodiments, the present invention provides a weighted composition for the treatment of a subterranean formation. The weighted composition includes a coated weighting agent. The coated weighting agent includes iron oxide and a crystalline inorganic coating material on the iron oxide, wherein the crystalline inorganic coating material is chosen from barium sulfate, calcium carbonate, and combinations thereof.

In various embodiments, the present invention provides a method of preparing a weighted composition for the treatment of a subterranean formation. The method includes forming a weighted composition including a coated weighting agent. The method includes forming a coated weighting agent including a weighting agent and an inorganic coating material on the weighting agent.

In various embodiments, the weighted composition, including the coated weighting agent, can be tailored to lower the abrasion character of the weighting agent. To that end, employing the weighted composition, including the coated weighting agent, in drilling fluids can reduce damage to equipment and increase the longevity of such equipment. As such, the weighted composition, including the weighted coating agent, can decrease the cost of drilling operations, as the demand to replace or repair equipment may be decreased.

In various embodiments, the coated weighting agent can be less expensive as compared to other materials. In various embodiments, the coated weighting agent can be less expensive per unit volume than weighting materials made from a single compound (e.g. barium sulfate), making the coated weighting agent less expensive per unit volume than weighting materials made from a single compound.

In various embodiments, the specific gravity of the inorganic coating material can effectively be increased by depositing it onto the surface of a weighting agent that has a higher specific gravity. In various embodiments, the crystalline inorganic coating material and weighting agent can be selected so that the resulting coated weighting agent is at least partially acid soluble. In various embodiments, the viscosity of the weighted composition can be more precisely modified by employing a coated weighting agent when compared to a corresponding weighted composition without the coated weighting agent. In various embodiments, the settling rate of the weighted composition can be more precisely modified by employing a coated weighting agent when compared to a corresponding weighted composition without the coated weighting agent. In various embodiments, the weighted composition can have a positive impact on filtration and filter cakes. In various embodiments, the weighted composition can be altered to positively affect the separation efficiency when using conventional equipment.

### Method of Treating a Subterranean Formation

In various embodiments, the present invention provides a method of treating a subterranean formation. The method includes placing in a subterranean formation a weighted composition including a coated weighting agent including a weighting agent and an inorganic coating material on (e.g., contacting) the weighting agent. The coated weighting agent can have similar weighting characteristics to the weighting agent but with reduced abrasive qualities and increased lubricity due to the inorganic coating material.

The placing of the weighted composition in the subterranean formation can include contacting the composition and any suitable part of the subterranean formation, or contacting the weighted composition and a subterranean material, such as any suitable subterranean material. In some examples, the placing of the weighted composition in the subterranean formation includes contacting the weighted composition with or placing the weighted composition in at least one of a fracture, at least a part of an area surrounding a fracture, a flow pathway, an area surrounding a flow pathway, and an area desired to be fractured. The placing of the weighted composition in the subterranean formation can be any suitable placing and can include any suitable contacting between the subterranean formation and the weighted composition. The placing of the weighted composition in the subterranean formation can include at least partially depositing the weighted composition in a fracture, flow pathway, or area surrounding the same. The obtaining or providing of the weighted composition can occur at any suitable time and at any suitable location. The obtaining or providing of the weighted composition can occur above the surface. The obtaining or providing of the weighted composition can occur in the subterranean formation (e.g., downhole).

In some embodiments, the method can be a method of drilling, stimulation, fracturing, spotting, clean-up, completion, remedial treatment, applying a pill, acidizing, cementing, packing, spotting, or a combination thereof.

In some embodiments, the weighted composition is a drilling fluid or further includes a drilling fluid. A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill bit as well as reduce friction between the drill string and the sides of the hole. The drilling fluid aids in support of the drill pipe and drill bit, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase. A drilling fluid can be present in the weighted composition or a mixture including the same in any suitable amount, such as about 1 wt. % or less, about 2 wt. %, 3, 4, 5, 10, 15, 20, 30, 40, 50, 60, 70, 80, 85, 90, 95, 96, 97, 98, 99, 99.9, 99.99, or about 99.999 wt. % or more.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), an aqueous base (e.g., sodium hydroxide or potassium hydroxide), an alcohol or polyol, cellulose, a starch, an alkalinity control agent, a density control agent such as a density modifier (e.g., barium sulfate), a surfactant (e.g., betaines, alkali metal alkylene acetates, sultaines, ether carboxylates), as emulsifier, a dispersant, a polymeric stabilizer, a crosslinking agents, a polyacrylamide, a polymers or a combination of polymers, an antioxidant, a heat stabilizers, a foam control agent, a solvent, a diluent, a plasticizer, a filler or inorganic particle (e.g., silica), a pigment, a dye, a precipitating agent (e.g., silicates or aluminum complexes), and a rheology modifier such as a thickener or viscosifier (e.g., xanthan gum). Any ingredient listed in this paragraph can be either present or not present in the mixture.

An oil-based drilling fluid or mud in embodiments of the present invention can be any suitable oil-based drilling fluid. In various embodiments the drilling fluid can include at least one of an oil-based fluid (or synthetic fluid), saline, aqueous solution, emulsifiers, other agents or additives for suspension control, weight or density control, oil-wetting agents, fluid loss or filtration control agents, and rheology control agents. An oil-based or invert emulsion-based drilling fluid can include between about 10:90 to about 95:5, or about 50:50 to about 95:5, by volume of oil phase to water phase. A substantially all oil mud includes about 100% liquid phase oil by volume (e.g., substantially no internal aqueous phase).

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

The method can include hydraulic fracturing, such as a method of hydraulic fracturing to generate a fracture or flow pathway. The placing of the weighted composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). The method can include performing a stimulation treatment at least one of before, during, and after placing the weighted composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the weighted composition is placed or contacted, or the weighted composition is placed or contacted to an area surrounding the generated fracture or flow pathway.

In some embodiments, the method further includes obtaining or providing the weighted composition, wherein the obtaining or providing of the weighted composition occurs above-surface. In some embodiments, the method further includes obtaining or providing the weighted composition, wherein the obtaining or providing of the weighted composition occurs in the subterranean formation.

In some embodiments, the viscosity of the weighted composition is different vis-à-vis a corresponding composition without the coated weighting agent. The viscosity of the weighted composition can be greater than the viscosity of the corresponding composition without the coated weighting agent. In some embodiments, the viscosity of the weighted composition is less than the viscosity of the corresponding composition without the coated weighting agent. In some embodiments, the viscosity of the weighted composition including a drilling fluid is different than the viscosity of the corresponding composition without the coated weighting agent. The viscosity of the weighted composition including a drilling fluid can be greater than the viscosity of the corresponding composition without the coated weighting agent. The viscosity of the weighted composition including a drilling fluid can be less than the viscosity of the corresponding composition without the coated weighting agent.

In various embodiments, the viscosity of the weighted composition can be modified by modifying the morphology of the coated weighting agent. In some embodiments, the viscosity of the weighted composition can be increased by modifying the morphology of the weighted composition. The viscosity of the weighted composition can be increased by increasing the morphological complexity of the surface of the coated weighting agent. The morphological complexity of the surface of the coated weighting agent can be increased by increasing the number, size, and/or complexity of the crystalline inorganic coating material crystals on the weighting agent. The morphological complexity of the surface of the coated weighting agent can be increased by increasing the number, size, and/or complexity of the amorphous inorganic coating material on the weighting agent. In some embodiments, the viscosity of the weighted composition can be decreased by modifying the morphology of the weighted composition. The morphological complexity of the surface of the coated weighting agent can be decreased by decreasing the number, size, and/or complexity of the crystalline inorganic coating material crystals on the weighting agent. The morphological complexity of the surface of the coated weighting agent can be decreased by decreasing the number, size, and/or complexity of the amorphous inorganic coating material on the weighting agent. The surface of the coated weighting agent can be made less morphologically complex by decreasing the number, size, and/or complexity of the crystalline inorganic coating material crystals on the weighting agent.

In some embodiments, the method further includes combining the weighted composition with an aqueous or oil-based fluid including a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof, to form a mixture, wherein the placing the weighted composition in the subterranean formation includes placing the mixture in the subterranean formation. The cementing fluid can include Portland cement, pozzolana cement, gypsum cement, high alumina content cement, slag cement, silica cement, or a combination thereof.

In some embodiments, prior to, during, or after placing the weighted composition in the subterranean formation, the weighted composition is used in the subterranean formation, either alone or in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof.

In some embodiments, the method includes placing the weighted composition in a subterranean formation and fracturing at least part of the subterranean formation to form at least one subterranean fracture.

In some embodiments, the method includes pumping the weighted composition through a tubular disposed in a wellbore and into the subterranean formation to place the weighted composition in a subterranean formation. In some embodiments, the method includes placing the weighted composition in the subterranean formation by pumping the weighted composition through a drill string disposed in a wellbore, through a drill bit at a downhole end of the drill string, and back above-surface through an annulus. Further, the method can include processing the weighted composition exiting the annulus with at least one fluid processing unit to generate a cleaned weighted composition and recirculating the cleaned weighted composition through the wellbore.

In various embodiments, the method includes placing in a subterranean formation a weighted composition including a coated weighting agent. The coated weighting agent can include an iron oxide and a crystalline inorganic coating material on the iron oxide. The crystalline inorganic coating material can be barium sulfate, calcium carbonate, and combinations thereof.

### Coated Weighting Agent

The weighted composition includes a weighting agent and an inorganic coating material contacting the weighting agent. As used herein, a “weighting agent” refers to a material that may be used to increase density of a subterranean treatment fluid, such as a drilling fluid. As used herein, the term “inorganic coating material,” refers to any suitable material that can be deposited on the weighting agent. When deposited on the weighting agent the inorganic coating material may be of crystalline form or amorphous form. As used herein, the term “crystalline inorganic coating material” refers to a material having a crystalline form with one or more substantially uniform or repetitious spatial parameters (e.g., lattice plane spacing, unit cell dimensions, unit cell configurations, etc.)—when deposited on the weighting agent. As used herein, the term “amorphous inorganic coating material” refers to a material that does not possess a distinguishable crystal structure (e.g., an amorphous form)—when deposited on the weighting agent.

In some embodiments, the coated weighting agent can be formed by growing the crystalline inorganic coating material on the weighting agent. Growing the crystalline inorganic coating material on the weighting agent can include allowing the weighting agent to facilitate the deposition or crystallization of the crystalline inorganic coating material onto the weighting agent. In some embodiments, the coated weighting agent is made by a process of growing crystals of the crystalline inorganic coating material on the weighting agent.

In some embodiments the coated weighting agent has a different specific gravity than the inorganic coating material used to form the coated weighting agent. The coated weighting agent can have a higher specific gravity that the inorganic coating material used to form the coated weighting agent. Alternatively, the coated weighting can have a lower specific gravity that the inorganic coating material used to form the coated weighting agent. The specific gravity generally is referenced to water.

In some embodiments, the coated weighting agent has a different specific gravity than the weighting agent used to form the coated weighting agent. The coated weighting agent can have a higher specific gravity than the weighting agent used to form the coated weighting agent. Alternatively, the coated weighting agent can have a higher specific gravity than the weighting agent used to form the coated weighting agent.

In some embodiments, the coated weighting agent has a specific gravity of at least about 2.6. In some embodiments, the coated weighting agent has a specific gravity of about 2.6-20, 3.0-19, 4-18, 5-17, 5.5-16, 6-15, 6.5-14, 7-13, 8-12, or about 9-11 or about 2.6, 3, 4, 5, 6, 7, 8, 9, 10, 11, 12, 13, 14, 15, 16, 17, 18, 19, or about 20.

In various embodiments, the coated weighting agent can include a weighting agent that is at least partially acid soluble. In some embodiments the weighting agent can be acid soluble. The term “acid soluble” refers to a material that is substantially soluble at a pH of less than about 6.5 and substantially insoluble at a pH of greater than about 7.0. In some embodiments, the weighting agent can be acid soluble, such as substantially soluble at a pH of about 6.5, 6, 5.5, 5, 4.5, 4, 3.5, 3.0, 2.5, or 2.0. In some embodiments, the acid soluble weighting agent can be substantially insoluble at a pH of about 7, 7.5, 8, 8.5, 9, 9.5, 10.0, 10.5, or 11. In some embodiments, about 1-25 wt. %, 25-50 wt. %, 50-75 wt. %, 75-100 wt. %, 1-10 wt. %, 10-20 wt. %, 20-30 wt. %, 30-40 wt. %, 40-50 wt. %, 50-60 wt. %, 60-70 wt. %, 70-80 wt. %, 80-90 wt. %, 90-100 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. % or about 100 wt. % of the weighting agent is soluble at a pH of less than about 6.5.

In various embodiments, the coated weighting agent can include an inorganic coating material that is at least partially acid soluble. In some embodiments, the inorganic coating material can be acid soluble. In some embodiments, about 1-25 wt. %, 25-50 wt. %, 50-75 wt. %, 75-100 wt. %, 1-10 wt. %, 10-20 wt. %, 20-30 wt. %, 30-40 wt. %, 40-50 wt. %, 50-60 wt. %, 60-70 wt. %, 70-80 wt. %, 80-90 wt. %, 90-100 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. % or about 100 wt. % of the inorganic coating material is soluble at a pH of less than about 6.5.

In various embodiments, the coated weighting agent can be at least partially acid soluble (e.g. hematite coated with calcium carbonate). In some embodiments, the coated weighting agent can be acid soluble. In some embodiments, about 1-25 wt. %, 25-50 wt. %, 50-75 wt. %, 75-100 wt. %, 1-10 wt. %, 10-20 wt. %, 20-30 wt. %, 30-40 wt. %, 40-50 wt. %, 50-60 wt. %, 60-70 wt. %, 70-80 wt. %, 80-90 wt. %, 90-100 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. % or about 100 wt. % of the coated weighting agent is soluble at a pH of less than about 6.5.

In various embodiments, the coated weighting agent has a particle size of about 1-1,000 μm. The term “particle size” as used herein refers to diameter of the particle using the largest dimension of the particle. For example, a rod-like particle would have diameter based on the length of the rod-like particle. In some embodiments, the coated weighting agent has a particle size of about 0.1-10 μm, 0.1-20 μm, 0.1-30 μm, 0.1-40 μm, 0.1-50 μm, 0.1-60 μm, 0.1-70 μm, 0.1-80 μm, 0.1-90 μm, 0.1-100 μm, 0.1-200 μm, 0.1-300 μm, 0.1-400 μm, 0.1-500 μm, 0.1-600 μm, 0.1-700 μm, 0.1-800 μm, 0.1-900 μm, 0.1-1,000 μm, 10-1,000 μm, 20-1,000 μm, 30-1,000 μm, 40-1,000 μm, 50-1,000 μm, 60-1,000 μm, 70-1,000 μm, 80-1,000 μm, 90-1,000 μm, 100-1,000 μm, 200-1,000 μm, 300-1,000 μm, 400-1,000 μm, 500-1,000 μm, 600-1,000 μm, 700-1,000 μm, 800-1,000 μm, 900-1,000 μm, 100-900 μm, 200-800 μm, 300-700 μm, or about 400-600 μm or about 1 μm, 5 μm, 10 μm, 15 μm, 20 μm, 25 μm, 30 μm, 35 μm, 40 μm, 45 μm, 50 μm, 60 μm, 65 μm, 70 μm, 80 μm, 90 μm, 100 μm, 150 μm, 200 μm, 300 μm, 400 μm, 500 μm, 600 μm, 700 μm, 800 μm, 900 μm, 1000 μm. In some embodiments, the coated weighting agent has a particle size of at least about 1 μm, 5 μm, 10 μm, 15 μm, 20 μm, 30 μm, 40 μm, 50 μm, 60 μm, 70 μm, 80 μm, 90 μm, or at least about 100 μm.

In some embodiments, the coated weighting agent is less abrasive than the corresponding weighting agent that is free of the inorganic coating material. The term “abrasive” as used herein refers to ability of one material to wear away at another material.

In various embodiments, the inorganic coating material is about 1 wt. % to about 50 wt. % of the coated weighting agent. The inorganic coating material can be about 1-5 wt. %, 1-10 wt. %, 1-15 wt. %, 1-20 wt. %, 1-25 wt. %, 1-30 wt. %, 1-35 wt. %, 1-40 wt. %, 1-45 wt. %, 1-50 wt. %, 5-15 wt. %, 5-20 wt. %, 5-25 wt. %, 5-30 wt. %, 5-35 wt. %, 5-40 wt. %, 5-45 wt. %, 5-50 wt. %, 10-30 wt. %, 10-50 wt. %, 1-5 wt. %, 5-10 wt. %, 10-15 wt. %, 15-20 wt. %, 20-25 wt. %, 25-30 wt. %, 30-35 wt. %, 35-40 wt. %, 40-45 wt. %, 45-50 wt. %, 50-99 wt. %, 55-99 wt. %, 60-99 wt. %, 65-99 wt. %, 70-99 wt. %, 75-99 wt. %, 80-99 wt. %, 85-99 wt. % 90-99 wt. %, 95 wt. % or about 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, or about 99 wt. % of the coated weighting agent.

In some embodiments, the inorganic coating material covers about 10% to about 50% of the surface of the weighting agent. The inorganic coating material can cover about 1-50%, 50-100%, 1%-20%, 20%-60%, 60%-100%, 20%-40%, 40%-60%, 60%-80%, or about 80%-100%, or about 5%, 10%, 15%, 20%, 25%, 30%, 35%, 40%, 45%, 50%, 55%, 60%, 65%, 70%, 75%, 80%, 85%, 90%, 95%, or about 100% of the surface of the weighting agent. The term “cover” and “covers,” with respect to the crystalline material covering the weighting agent, refers to the ability of the inorganic coating material to substantially prevent the surface of the weighting agent from causing abrasion to other materials. In some embodiments, the covered surface can be calculated by scanning electron microscopy or other suitable methods.

### Weighting Agent

The weighted composition includes a weighting agent. In various embodiments, the weighting agent can be chosen from hard minerals, metal oxides, metal particles, metal alloys, and combinations thereof. The weighting agent can be chosen from Al₂O₃, Al₂SiO₅, BiO₃, Bi₂O₃, CaSO₄, CaPO₄, CdS, Ce₂O₃, (Fe,Mg)Cr₂O₄, Cr₂O₃, CuO, Cu₂O, Cu₂(AsO₄)(OH), CuSiO₃.H₂O, Fe₃Al₂(SiO₄)₃, Fe²⁺Al₂O₄, Fe₂SiO₄, FeCO₃, Fe₂O₃, α-Fe₂O₃, α-FeO(OH), Fe₃O₄, FeTiO₃, (Fe,Mg)SiO₄, (Mn,Fe,Mg)(Al,Fe)₂O₄, CaFe²⁺2Fe³+Si₂O₇O(OH), (YFe³⁺Fe²⁺U,Th, Ca)₂(Nb,Ta)₂O₈, MgO, Mn₂SiO₄, Mn(II)₃Al₂(SiO₄)₃, (Na_{0.3}Ca_{0.1}K_{0.1})(Mn⁴⁺,Mn³⁺)₂O₄.1.5H₂O, (Mn,Fe)₂O₃, (Mn²⁺,Fe²⁺,Mg)(Fe³⁺,Mn³⁺)₂O₄, (Mn²⁺,Mn³⁺)₆[(O₈)(SiO₄)], Ca(Mn³⁺,Fe³⁺)₁₄SiO₂₄, Ba(Mn²⁺)(Mn⁴⁺)₈O₁₆(OH)₄, CaMoO₄, MoO₂, MoO₃, NbO₄, (Na,Ca)₂Nb₂O₆(OH,F), (Y,Ca,Ce,U,Th)(Nb,Ta,Ti)₂O₆, (Y,Ca,Ce,U,Th)(Ti,Nb,Ta)₂O₆, (Fe,Mn)(Ta,Nb)₂O₆, (Ce,La,Ca)BSiO₅, (Ce,La)CO₃F, (Y,Ce)CO₃F, MnO, MnO₂, Mn₂O₃, Mn₃O₄, Mn₂O₇, MnO(OH), (Mn²⁺,Mn³⁺)₂O₄, NiO, NiAs₂, NiAs, NiAsS, Ni₂Fe to Ni₃Fe, (Ni,Co)₃S₄, PbSiO₃, PbCO₃, (PbCl)₂CO₃, Pb²⁺2Pb⁴⁺O4, PbCu[(OH)₂(SO₄)], (Sb³⁺,Sb⁵⁺)O₄, Sb₂SnO₅, Sc₂O₃, SnO, SnO₂, Cu₂FeSnS₄, SrO, SrSO₄, SrCO₃, (Na,Ca)₂Ta₂O₆(O,OH,F), ThO₂, (Th,U)SiO₄, TiO₂, UO₂, V₂O₃, VO₂, V₂O₅, Pb₅(VO₄)₃Cl, VaO, Y₂O₃, ZnCO₃, ZnO, ZnFe₂O₄, ZnAl₂O₄, ZnCO₃, ZnO, ZrSiO₄, ZrO₂, ZrSiO₄, allemontite, altaite, aluminum oxide, anglesite, tin oxide, antimony trioxide, awaruite, barium sulfate, bastnaesite, beryllium oxide, birnessite, bismite, bismuth oxycarbonates, bismuth oxychloride, bismuth trioxide, bismuth (III) oxide, bixbyite, bournonite, braunite, brucite, cadimum sulfide, calayerite, calcium oxide, calcium carbonate, cassiterite, cerium oxide, cerussite, chromium oxide, clinoclase, columbite, copper, copper oxide, corundum, crocoite, cuprite, dolomite, euxenite, fergusonite, franklinite, gahnite, geothite, greenockite, hausmmanite, hematite, hercynite, hessite, ilvaite, Jacobsite, magnesium oxide, manganite, manganosite, magnetite, manganese dioxide, manganese (IV) oxide, manganese oxide, manganese tetraoxide, manganese (II) oxide, manganese (III) oxide, microlite, minium, molybdenum (IV) oxide, molybdenum oxide, molybdenum trioxide, nickel oxide, pearceite, phosgenite, psilomelane, pyrochlore, pyrolusite, rutile, scandium oxide, siderite, smithsonite, spessartite, stillwellite, stolzite, strontium oxide, tantalite, tenorite, tephroite, thorianite, thorite, tin dioxide, tin (II) oxide, titanium dioxide, vanadium oxide, vanadium trioxide, vanadium (IV) oxide, vanadium (V) oxide, witherite, wulfenite, yttrium oxide, zincite, zircon, zirconium oxide, zirconium silicate, zinc oxide, and combinations thereof. In some embodiments, the weighting agent can be chosen from iron, nickel and combinations thereof.

In some embodiments, the weighting agent has a specific gravity of about 2.6-20, 3.0-19, 4-18, 5-17, 5.5-16, 6-15, 6.5-14, 7-13, 8-12, or about 9-11 or about 2.6, 3, 4, 5, 6, 7, 8, 9, 10, 11, 12, 13, 14, 15, 16, 17, 18, 19, or about 20.

### Inorganic Coating Material

The coated weighting agent includes an inorganic coating material on the weighting agent. In various embodiments, the inorganic coating material can be a crystalline inorganic coating material. In various embodiments, the inorganic coating material can be an amorphous inorganic coating material.

In various embodiments, the crystalline inorganic coating material can include a first ion and a corresponding second counterion. In various embodiments, the crystalline inorganic coating material can be chosen from calcium salts, barium salts, bismuth salts, aluminum salts, sodium salts, potassium salts, iron salts, nickel salts, cadmium salts, cesium salts, strontium salts, magnesium salts, zinc salts, lead salts, and mixtures thereof. In some embodiments, the crystalline inorganic coating material is chosen from As₂S₃, BaCO₃, (BiO)₂CO₃, (Ca,Mg)CO₃, FeCO₃, PbCO₃, (PbCl)₂CO₃, PbCu(OH)₂(SO₄), Sb₂S₃, SnS, SnS₂, Sn₂S₃, SrSO₄, SrCO₃, ZnCO₃, ankerite (e.g., CaFe(CO₃)₂), aluminum phosphate, aluminum sulfate, barium phosphate, barium sulfide, barium sulfate, beryllium sulfide, bismuth sulfide, calcium oxalate, calcium sulfide, calcium phosphate, calcium sulfate, calcium citrate, calcium carbonate, calcite, aragonite, manganese carbonate, gaspite (e.g., (Ni,Mg,Fe²⁺)CO₃), huntite (e.g., Mg₃Ca(CO₃)₄), magnesite, nickel carbonate, strontium sulfide, thallium sulfide, and mixtures thereof.

In various embodiments, the amorphous inorganic coating material can be chosen from phosphates, carbonates, silicates, tungstates, molybdates, aluminates, titanates, sulfates, sulfides, oxides, hydroxides, silicates, silica, inorganic carbon compounds (e.g., graphite and carbonates), and mixtures thereof. In some embodiments, the amorphous inorganic coating material can be chosen from As₂S₃, BaCO₃, (BiO)₂CO₃, (Ca,Mg)CO₃, FeCO₃, PbCO₃, (PbCl)₂CO₃, PbCu(OH)₂(SO₄), Sb₂S₃, SiO₂, SnS, SnS₂, Sn₂S₃, SrSO₄, SrCO₃, ZnCO₃, aluminum silicate, aluminum phosphate, aluminum sulfate, barium phosphate, barium sulfide, barium sulfate, bismuth sulfide, calcium oxalate, calcium silicate, calcium sulfide, calcium phosphate, calcium sulfate, calcium citrate, calcium tungstate, copper sulfide, graphite, iron sulfide, manganese carbonate, molybdenum disulfide, lithium iron(II) silicate, nickel carbonate, potassium silicate, strontium silicate aluminate, strontium sulfide, tungsten disulfide, zinc sulfide, zirconium(IV) silicate, and mixtures thereof.

### Other Components.

The weighted composition including the coated weighting agent, or a mixture including the weighted composition, can include any suitable additional component in any suitable proportion, such that the coated weighting agent, weighted composition, or mixture including the same, can be used as described herein.

In some embodiments, the weighted composition includes one or more viscosifiers. The viscosifier can be any suitable viscosifier. The viscosifier can affect the viscosity of the weighted composition or a solvent that contacts the weighted composition at any suitable time and location. In some embodiments, the viscosifier provides an increased viscosity at least one of before injection into the subterranean formation, at the time of injection into the subterranean formation, during travel through a tubular disposed in a borehole, once the weighted composition reaches a particular subterranean location, or some period of time after the weighted composition reaches a particular subterranean location. In some embodiments, the viscosifier can be about 0.000.1 wt. % to about 10 wt. % of the weighted composition or a mixture including the same, about 0.004 wt. % to about 0.01 wt. %, or about 0.000.1 wt. % or less, 0.000.5 wt. %, 0.001, 0.005, 0.01, 0.05, 0.1, 0.5, 1, 2, 3, 4, 5, 6, 7, 8, 9, or about 10 wt. % or more of the composition or a mixture including the same.

The viscosifier can include at least one of a substituted or unsubstituted polysaccharide, and a substituted or unsubstituted polyalkene (e.g., a polyethylene, wherein the ethylene unit is substituted or unsubstituted, derived from the corresponding substituted or unsubstituted ethene), wherein the polysaccharide or polyalkene is crosslinked or uncrosslinked. The viscosifier can include a polymer including at least one repeating unit derived from a monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. The viscosifier can include a crosslinked gel or a crosslinkable gel. The viscosifier can include at least one of a linear polysaccharide, and a poly((C₂-C₁₀)alkene), wherein the (C₂-C₁₀)alkene is substituted or unsubstituted. The viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, derivatized dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, diutan, welan, starch, derivatized starch, tamarind, tragacanth, guar gum, derivatized guar gum (e.g., hydroxypropyl guar, carboxy methyl guar, or carboxymethyl hydroxypropyl guar), gum ghatti, gum arabic, locust bean gum, cellulose, and derivatized cellulose (e.g., carboxymethyl cellulose, hydroxyethyl cellulose, carboxymethyl hydroxyethyl cellulose, hydroxypropyl cellulose, or methyl hydroxy ethyl cellulose).

In some embodiments, the viscosifier can include at least one of a poly(vinyl alcohol) homopolymer, poly(vinyl alcohol) copolymer, a crosslinked poly(vinyl alcohol) homopolymer, and a crosslinked poly(vinyl alcohol) copolymer. The viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstitued (C₂-C₅₀)hydrocarbyl having at least one aliphatic unsaturated C—C bond therein, and a substituted or unsubstituted (C₂-C₅₀)alkene. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂₀)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N—(C₁-C₁₀)alkenyl nitrogen containing substituted or unsubstituted (C₁-C₁₀)heterocycle. The viscosifier can include a poly(vinyl alcohol) copolymer or a crosslinked poly(vinyl alcohol) copolymer including at least one of a graft, linear, branched, block, and random copolymer that includes a poly(vinylalcohol/acrylamide) copolymer, a poly(vinylalcohol/2-acrylamido-2-methylpropanesulfonic acid) copolymer, a poly (acrylamide/2-acrylamido-2-methylpropanesulfonic acid) copolymer, or a poly(vinylalcohol/N-vinylpyrrolidone) copolymer. The viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

In various embodiments, the weighted composition can include one or more crosslinkers. The crosslinker can be any suitable crosslinker. In some examples, the crosslinker can be incorporated in a crosslinked viscosifier, and in other examples, the crosslinker can crosslink a crosslinkable material (e.g., downhole). The crosslinker can include at least one of chromium, aluminum, antimony, zirconium, titanium, calcium, boron, iron, silicon, copper, zinc, magnesium, and an ion thereof. The crosslinker can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate. In some embodiments, the crosslinker can be a (C₁-C₂₀)alkylenebiacrylamide (e.g., methylenebisacrylamide), a poly((C₁-C₂₀)alkenyl)-substituted mono- or poly-(C₁-C₂₀)alkyl ether (e.g., pentaerythritol allyl ether), and a poly(C₂-C₂₀)alkenylbenzene (e.g., divinylbenzene). In some embodiments, the crosslinker can be at least one of alkyl diacrylate, ethylene glycol diacrylate, ethylene glycol dimethacrylate, polyethylene glycol diacrylate, polyethylene glycol dimethacrylate, ethoxylated bisphenol A diacrylate, ethoxylated bisphenol A dimethacrylate, ethoxylated trimethylol propane triacrylate, ethoxylated trimethylol propane trimethacrylate, ethoxylated glyceryl triacrylate, ethoxylated glyceryl trimethacrylate, ethoxylated pentaerythritol tetraacrylate, ethoxylated pentaerythritol tetramethacrylate, ethoxylated dipentaerythritol hexaacrylate, polyglyceryl monoethylene oxide polyacrylate, polyglyceryl polyethylene glycol polyacrylate, dipentaerythritol hexaacrylate, dipentaerythritol hexamethacrylate, neopentyl glycol diacrylate, neopentyl glycol dimethacrylate, pentaerythritol triacrylate, pentaerythritol trimethacrylate, trimethylol propane triacrylate, trimethylol propane trimethacrylate, tricyclodecane dimethanol diacrylate, tricyclodecane dimethanol dimethacrylate, 1,6-hexanediol diacrylate, and 1,6-hexanediol dimethacrylate. The crosslinker can be about 0.000.01 wt. % to about 5 wt. % of the weighted composition or a mixture including the same, about 0.001 wt. % to about 0.01 wt. %, or about 0.000.01 wt. % or less, or about 0.000.05 wt. %, 0.000,1, 0.000,5, 0.001, 0.005, 0.01, 0.05, 0.1, 0.5, 1, 2, 3, 4, or about 5 wt. % or more.

In some embodiments, the weighted composition can include one or more breakers. The breaker can be any suitable breaker, such that the surrounding fluid (e.g., a fracturing fluid) can be at least partially broken for more complete and more efficient recovery thereof, such as at the conclusion of the hydraulic fracturing treatment. In some embodiments, the breaker can be encapsulated or otherwise formulated to give a delayed-release or a time-release of the breaker, such that the surrounding liquid can remain viscous for a suitable amount of time prior to breaking. The breaker can be any suitable breaker; for example, the breaker can be a compound that includes a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion. In some examples, the breaker can be an oxidative breaker or an enzymatic breaker. An oxidative breaker can be at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyporchlorite ion. An enzymatic breaker can be at least one of an alpha or beta amylase, amyloglucosidase, oligoglucosidase, invertase, maltase, cellulase, hemi-cellulase, and mannanohydrolase. The breaker can be about 0.001 wt. % to about 30 wt. % of the weighted composition or a mixture including the same, or about 0.01 wt. % to about 5 wt. %, or about 0.001 wt. % or less, or about 0.005 wt. %, 0.01, 0.05, 0.1, 0.5, 1, 2, 3, 4, 5, 6, 8, 10, 12, 14, 16, 18, 20, 22, 24, 26, 28, or about 30 wt. % or more.

The weighted composition, or a mixture including the weighted composition, can include any suitable fluid. For example, the fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt. % to about 99.999 wt. % of the composition, or a mixture including the same, or about 0.001 wt. % or less, 0.01 wt. %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt. % or more.

The weighted composition including the coated weighting agent or a mixture including the same can include any suitable downhole fluid. The weighted composition including the coated weighting agent can be combined with any suitable downhole fluid before, during, or after the placement of the weighted composition in the subterranean formation or the contacting of the weighted composition and the subterranean material. In some examples, the weighted composition including the coated weighting agent is combined with a downhole fluid above the surface, and then the combined composition is placed in a subterranean formation or contacted with a subterranean material. In another example, the weighted composition including the coated weighting agent is injected into a subterranean formation to combine with a downhole fluid, and the combined composition is contacted with a subterranean material or is considered to be placed in the subterranean formation. The placement of the weighted composition in the subterranean formation can include contacting the subterranean material and the mixture. Any suitable weight percent of the weighted composition or of a mixture including the same that is placed in the subterranean formation or contacted with the subterranean material can be the downhole fluid, such as about 0.001 wt. % to about 99.999 wt. %, about 0.01 wt. % to about 99.99 wt. %, about 0.1 wt. % to about 99.9 wt. %, about 20 wt. % to about 90 wt. %, or about 0.001 wt. % or less, or about 0.01 wt. %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt. %, or about 99.999 wt. % or more of the weighted composition or mixture including the same.

In some embodiments, the weighted composition, or a mixture including the same, can include any suitable amount of any suitable material used in a downhole fluid. For example, the weighted composition or a mixture including the same can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, salts (e.g., any suitable salt, such as potassium salts such as potassium chloride, potassium bromide, potassium formate; calcium salts such as calcium chloride, calcium bromide, calcium formate; cesium salts such as cesium chloride, cesium bromide, cesium formate, or a combination thereof), fibers, thixotropic additives, breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, lime, or a combination thereof. In various embodiments, the weighted composition or a mixture including the same can include one or more additive components such as: COLDTROL®, ATC®, OMC 2™, and OMC 42™ thinner additives; RHEMOD™ viscosifier and suspension agent; TEMPERUS™ and VIS-PLUS® additives for providing temporary increased viscosity; TAU-MOD™ viscosifying/suspension agent; ADAPTA®, DURATONE® HT, THERMO TONE™, BDF™-366, and BDF™-454 filtration control agents; LIQUITONE™ polymeric filtration agent and viscosifier; FACTANT™ emulsion stabilizer; LE SUPERMUL™, EZ MUL® NT, and FORTI-MUL® emulsifiers; DRIL TREAT® oil wetting agent for heavy fluids; BARACARB® bridging agent; BAROID® weighting agent; BAROLIFT® hole sweeping agent; SWEEP-WATE® sweep weighting agent; BDF-508 rheology modifier; and GELTONE® II organophilic clay. In various embodiments, the weighted composition or a mixture including the same can include one or more additive components such as: X-TEND® II, PAC™-R, PAC™-L, LIQUI-VIS® EP, BRINEDRIL-VIS™, BARAZAN®, N-VIS®, and AQUAGEL® viscosifiers; THERMA-CHEK®, N-DRIL™, N-DRIL™ HT PLUS, IMPERMEX®, FILTERCHEK™, DEXTRID®, CARBONOX®, and BARANEX® filtration control agents; PERFORMATROL®, GEM™, EZ-MUD®, CLAY GRABBER®, CLAYSEAL®, CRYSTAL-DRIL®, and CLAY SYNC™ II shale stabilizers; NXS-LUBE™, EP MUDLUBE®, and DRIL-N-SLIDE™ lubricants; QUIK-THIN®, IRON-THIN™, and ENVIRO-THIN™ thinners; SOURSCAV™ scavenger; BARACOR® corrosion inhibitor; and WALL-NUT®, SWEEP-WATE®, STOPPIT™, PLUG-GIT®, BARACARB®, DUO-SQUEEZE®, BAROFIBRE™, STEELSEAL®, and HYDRO-PLUG® lost circulation management materials. Any suitable proportion of the weighted composition or mixture including the weighted composition can include any optional component listed in this paragraph, such as about 0.001 wt. % to about 99.999 wt. %, about 0.01 wt. % to about 99.99 wt. %, about 0.1 wt. % to about 99.9 wt. %, about 20 to about 90 wt. %, or about 0.001 wt. % or less, or about 0.01 wt. %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt. %, or about 99.999 wt. % or more of the composition or mixture.

A cement fluid can include an aqueous mixture of at least one of cement and cement kiln dust. The weighted composition including the coated weighting agent can form a useful combination with cement or cement kiln dust. The cement kiln dust can be any suitable cement kiln dust. Cement kiln dust can be formed during the manufacture of cement and can be partially calcined kiln feed that is removed from the gas stream and collected in a dust collector during a manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with embodiments of the present invention; for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in embodiments of the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt. % to about 100 wt. %, about 0 wt. % to about 95 wt. %, about 20 wt. % to about 95 wt. %, or about 50 wt. % to about 90 wt. %. A cement kiln dust can be present in an amount of at least about 0.01 wt. %, or about 5 wt. % to about 80 wt. %, or about 10 wt. % to about 50 wt. %.

Optionally, other additives can be added to a cement or kiln dust-containing composition of embodiments of the present invention as deemed appropriate by one skilled in the art, with the benefit of this disclosure. Any optional ingredient listed in this paragraph can be either present or not present in the weighted composition. For example, the weighted composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

In various embodiments, the weighted composition or mixture can include a proppant, a resin-coated proppant, an encapsulated resin, or a combination thereof. A proppant is a material that keeps an induced hydraulic fracture at least partially open during or after a fracturing treatment. Proppants can be transported into the subterranean formation (e.g., downhole) to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ polytetrafluoroethylene), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, the proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The weighted composition or mixture can include any suitable amount of proppant, such as about 0.01 wt. % to about 99.99 wt. %, about 0.1 wt. % to about 80 wt. %, about 10 wt. % to about 60 wt. %, or about 0.01 wt. % or less, or about 0.1 wt. %, 1, 2, 3, 4, 5, 10, 15, 20, 30, 40, 50, 60, 70, 80, 85, 90, 91, 92, 93, 94, 95, 96, 97, 98, 99, about 99.9 wt. %, or about 99.99 wt. % or more.

### Drilling Assembly.

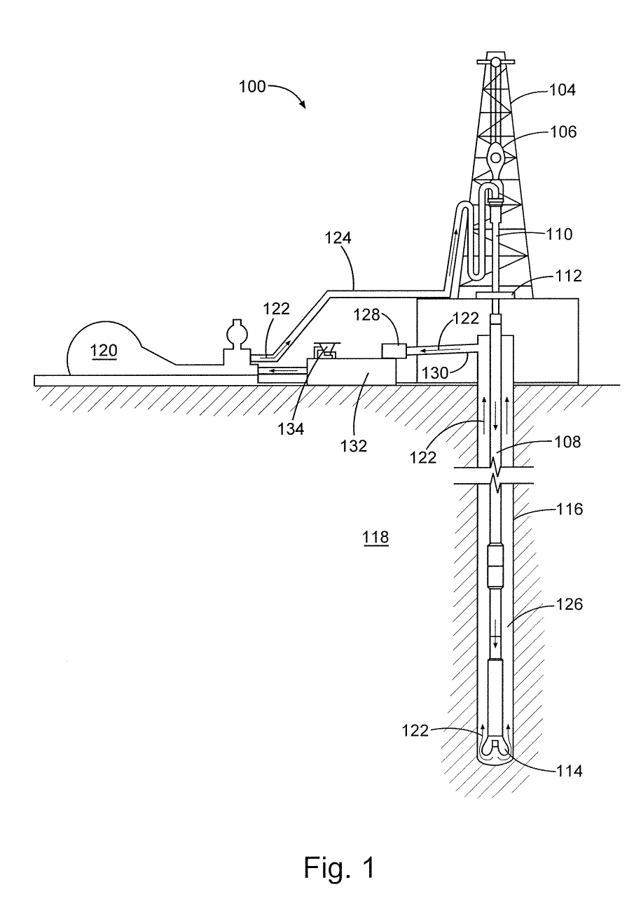

In various embodiments, the weighted composition including the coated weighting agent disclosed herein can directly or indirectly affect one or more components or pieces of equipment associated with the preparation, delivery, recapture, recycling, reuse, and/or disposal of the disclosed weighting composition including coated weighting agent. For example, and with reference to FIG. 1, the disclosed weighted composition including coated weighting agent can directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 can include a drilling platform 102 that supports a derrick 104 having a traveling block 106 for raising and lowering a drill string 108. The drill string 108 can include drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and can be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 can be arranged at any other location in the drilling assembly 100 to facilitate its proper function, without departing from the scope of the disclosure.

The weighted composition including coated weighting agent can be added to the drilling fluid 122 via a mixing hopper 134 communicably coupled to or otherwise in fluid communication with the retention pit 132. The mixing hopper 134 can include mixers and related mixing equipment known to those skilled in the art. In other embodiments, however, the weighted composition including coated weighting agent can be added to the drilling fluid 122 at any other location in the drilling assembly 100. In at least one embodiment, for example, there could be more than one retention pit 132, such as multiple retention pits 132 in series. Moreover, the retention pit 132 can be representative of one or more fluid storage facilities and/or units where the weighted composition including coated weighting agent can be stored, reconditioned, and/or regulated until added to the drilling fluid 122.

As mentioned above, the weighted composition including coated weighting agent can directly or indirectly affect the components and equipment of the drilling assembly 100. For example, the weighted composition including coated weighting agent can directly or indirectly affect the fluid processing unit(s) 128, which can include one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 can further include one or more sensors, gauges, pumps, compressors, and the like used to store, monitor, regulate, and/or recondition the weighted composition including coated weighting agent.

The weighted composition including coated weighting agent can directly or indirectly affect the pump 120, which representatively includes any conduits, pipelines, trucks, tubulars, and/or pipes used to fluidically convey the weighted composition including coated weighting agent to the subterranean formation, any pumps, compressors, or motors (e.g., topside or downhole) used to drive the weighted composition into motion, any valves or related joints used to regulate the pressure or flow rate of the composition, and any sensors (e.g., pressure, temperature, flow rate, and the like), gauges, and/or combinations thereof, and the like. The weighted composition including coated weighting agent can also directly or indirectly affect the mixing hopper 134 and the retention pit 132 and their assorted variations.

The weighted composition including coated weighting agent can also directly or indirectly affect the various downhole or subterranean equipment and tools that can come into contact with the weighted composition including coated weighting agent such as the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The weighted composition including coated weighting agent can also directly or indirectly affect any downhole heat exchangers, valves and corresponding actuation devices, tool seals, packers and other wellbore isolation devices or components, and the like associated with the wellbore 116. The weighted composition including coated weighting agent can also directly or indirectly affect the drill bit 114, which can include roller cone bits, polycrystalline diamond compact (PDC) bits, natural diamond bits, hole openers, reamers, coring bits, and the like.

While not specifically illustrated herein, the weighted composition including coated weighting agent can also directly or indirectly affect any transport or delivery equipment used to convey the weighted composition including coated weighting agent to the drilling assembly 100 such as, for example, any transport vessels, conduits, pipelines, trucks, tubulars, and/or pipes used to fluidically move the weighted composition including coated weighting agent from one location to another, any pumps, compressors, or motors used to drive the weighted composition into motion, any valves or related joints used to regulate the pressure or flow rate of the composition, and any sensors (e.g., pressure and temperature), gauges, and/or combinations thereof, and the like.

### System or Apparatus.

In various embodiments, the present invention provides a system. The system can be any suitable system that can use or that can be generated by use of an embodiment of the weighted composition described herein in a subterranean formation, or that can perform or be generated by performance of a method for using the weighted composition described herein. The system can include a weighted composition including coated weighting agent, which can include a weighting agent and an inorganic coating material contacting the weighting agent. The system can also include a subterranean formation including the weighted composition therein. In some embodiments, the weighted composition in the system can also include a downhole fluid, or the system can include a mixture of the weighted composition and downhole fluid. In some embodiments, the system can include a tubular, and a pump configured to pump the weighted composition into the subterranean formation through the tubular.

Various embodiments provide systems and apparatus configured for delivering the weighted composition described herein to a subterranean location and for using the weighted composition therein, such as for a drilling operation, or a fracturing operation (e.g., pre-pad, pad, slurry, or finishing stages). In various embodiments, the system or apparatus can include a pump fluidly coupled to a tubular (e.g., any suitable type of oilfield pipe, such as pipeline, drill pipe, production tubing, and the like), with the tubular containing a weighted composition including the coated weighting agent described herein.

In some embodiments, the system can include a drill string disposed in a wellbore, with the drill string including a drill bit at a downhole end of the drill string. The system can also include an annulus between the drill string and the wellbore. The system can also include a pump configured to circulate the weighted composition through the drill string, through the drill bit, and back above-surface through the annulus. In some embodiments, the system can include a fluid processing unit configured to process the weighted composition exiting the annulus to generate a cleaned drilling fluid for recirculation through the wellbore.

In various embodiments, the present invention provides an apparatus. The apparatus can be any suitable apparatus that can use or that can be generated by use of the weighted composition described herein in a subterranean formation, or that can perform or be generated by performance of a method for using the weighted composition described herein.

The pump can be a high pressure pump in some embodiments. As used herein, the term “high pressure pump” will refer to a pump that is capable of delivering a fluid to a subterranean formation (e.g., downhole) at a pressure of about 1000 psi or greater. A high pressure pump can be used when it is desired to introduce the weighted composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the weighted composition to the high pressure pump. In such embodiments, the low pressure pump can “step up” the pressure of the weighted composition before it reaches the high pressure pump.

In some embodiments, the systems or apparatuses described herein can further include a mixing tank that is upstream of the pump and in which the weighted composition is formulated. In various embodiments, the pump (e.g., a low pressure pump, a high pressure pump, or a combination thereof) can convey the weighted composition from the mixing tank or other source of the weighted composition to the tubular. In other embodiments, however, the weighted composition can be formulated offsite and transported to a worksite, in which case the weighted composition can be introduced to the tubular via the pump directly from its shipping container (e.g., a truck, a railcar, a barge, or the like) or from a transport pipeline. In either case, the weighted composition can be drawn into the pump, elevated to an appropriate pressure, and then introduced into the tubular for delivery to the subterranean formation.

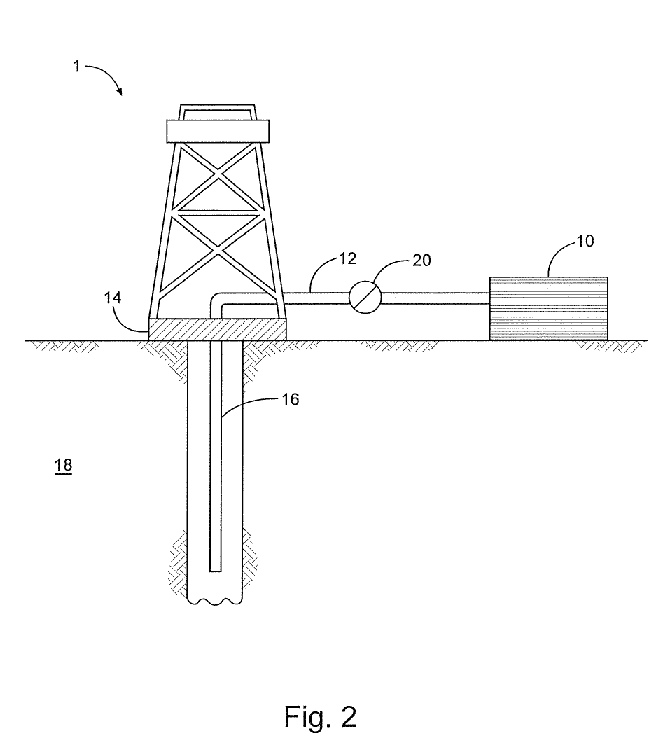

FIG. 2 shows an illustrative schematic of systems and apparatuses that can deliver embodiments of the weighted compositions of the present invention to a subterranean location, according to one or more embodiments. It should be noted that while FIG. 2 generally depicts a land-based system or apparatus, it is to be recognized that like systems and apparatuses can be operated in subsea locations as well. Embodiments of the present invention can have a different scale than that depicted in FIG. 2. As depicted in FIG. 2, system or apparatus 1 can include mixing tank 10, in which an embodiment of the weighted composition can be formulated. The weighted composition can be conveyed via line 12 to wellhead 14, where the weighted composition enters tubular 16, with tubular 16 extending from wellhead 14 into subterranean formation 18. Upon being ejected from tubular 16, the weighted composition can subsequently penetrate into subterranean formation 18. Pump 20 can be configured to raise the pressure of the weighted composition to a desired degree before its introduction into tubular 16. It is to be recognized that system or apparatus 1 is merely exemplary in nature and various additional components can be present that have not necessarily been depicted in FIG. 2 in the interest of clarity. In some examples, additional components that can be present include supply hoppers, valves, condensers, adapters, joints, gauges, sensors, compressors, pressure controllers, pressure sensors, flow rate controllers, flow rate sensors, temperature sensors, and the like.

Although not depicted in FIG. 2, at least part of the weighted composition can, in some embodiments, flow back to wellhead 14 and exit subterranean formation 18. The weighted composition that flows back can be substantially diminished in the concentration of coated weighting agent, or can have no coated weighting agent, therein. In some embodiments, the weighted composition that has flowed back to wellhead 14 can subsequently be recovered, and in some examples reformulated, and recirculated to subterranean formation 18.

It is also to be recognized that the disclosed weighted composition can also directly or indirectly affect the various downhole or subterranean equipment and tools that can come into contact with the weighted composition during operation. Such equipment and tools can include wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 2.

### Weighted Composition for Treatment of a Subterranean Formation.

Various embodiments provide a weighted composition for treatment of a subterranean formation. The weighted composition can be any suitable composition that can be used to perform an embodiment of the method for treatment of a subterranean formation described herein.

In various embodiments, the weighted composition can include a weighing agent. The weighted composition can include an inorganic coating material contacting the weighting agent. The inorganic coating material can be a crystalline inorganic coating material. The inorganic coating material can be an amorphous inorganic coating material.

In some embodiments, the weighted composition further includes a downhole fluid. The downhole fluid can be any suitable downhole fluid. In some embodiments, the downhole fluid is a composition for fracturing of a subterranean formation or subterranean material, or a fracturing fluid.

In some embodiments, the weighted composition is a composition for drilling of a subterranean formation.

In some embodiments, the weighted composition can include iron oxide and an inorganic coating material chosen from barium sulfate, calcium carbonate, and combinations thereof.

### Method for Preparing a Weighted Composition for Treatment of a Subterranean Formation.

In various embodiments, the present invention provides a method for preparing a weighted composition for treatment of a subterranean formation. The method can be any suitable method that produces a weighted composition described herein. For example, the method can include forming a weighted composition including a weighting agent and an inorganic coating material contacting the weighting agent.

In some embodiments, the method can include growing the crystalline inorganic coating material on the weighting agent. The term “growing,” as used herein, refers to dissolved solute particles coming out of solution and crystallizing on a solid surface.

In some embodiments, the method can include using the weighting agent to seed crystallization of the coated weighting agent. The term “seed crystallization,” as used herein, refers to providing a surface on which a dissolved solute can come out of solution and precipitate on to.

In some embodiments, the crystalline inorganic coating material comprises a first ion and a corresponding second counterion. The growing of the crystalline inorganic coating material on the weighting agent can include adding the weighting agent to a solution comprising water. The growing of the crystalline inorganic coating material can include adding a salt including the first ion of the crystalline inorganic coating material. The growing of the crystalline inorganic coating material can include adding a solution including a second corresponding counterion. The growing of the crystalline inorganic coating material can include forming the crystalline inorganic coating material on the weighting agent.

### EXAMPLES

Various embodiments of the present invention can be better understood by reference to the following Examples which are offered by way of illustration. The present invention is not limited to the Examples given herein.

### Example 1. Preparation and Analysis of Calcium Carbonate Coated Iron Oxide Particles

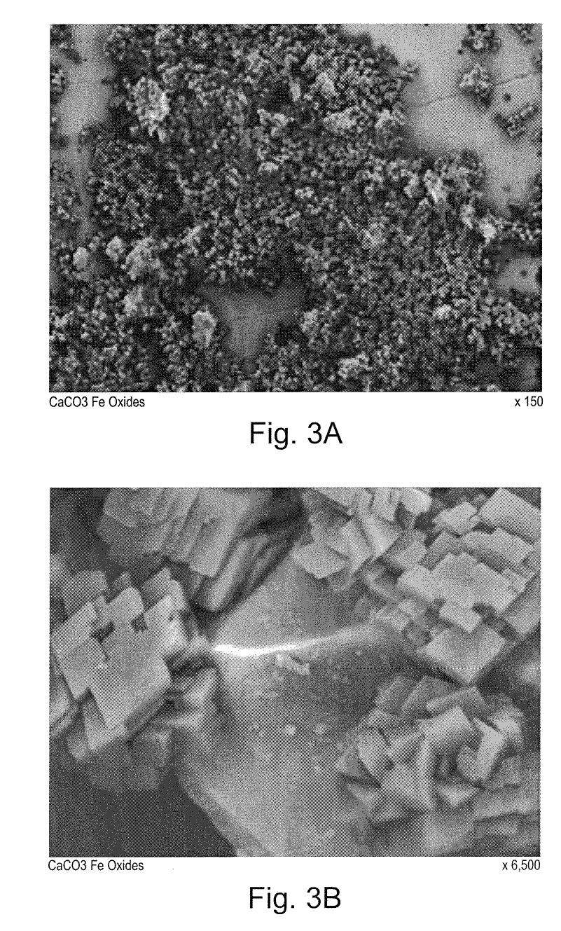

To 300 mL of deionized water, was added 100 g of hematite (Fe₂O₃). The solution was magnetically stirred at 700 rpm. The desired amount of Na₂CO₃ was added to the solution and soaked for 5 minutes until the salt was totally dissolved. Subsequently, 0.5M CaCl₂ solution with equal molar amounts of Ca²⁺ and CO₃²⁻ was added at 5 mL/min. The conditions (e.g. temperature and pH) can be controlled to obtain the desired CaCO₃ morphology. Calcium carbonate crystals were then allowed to grow on iron oxide particles. The iron oxide particles were successfully coated with CaCO₃. Scanning electron microscopy (SEM) was employed to analyze the v coated, iron oxide particles. A SEM image at 150 times magnification is shown in FIG. 3A, and a SEM image at 6,500 times magnification is shown in FIG. 3B.

### Example 2. Preparation and Analysis of Barite Coated Iron Oxide Particles

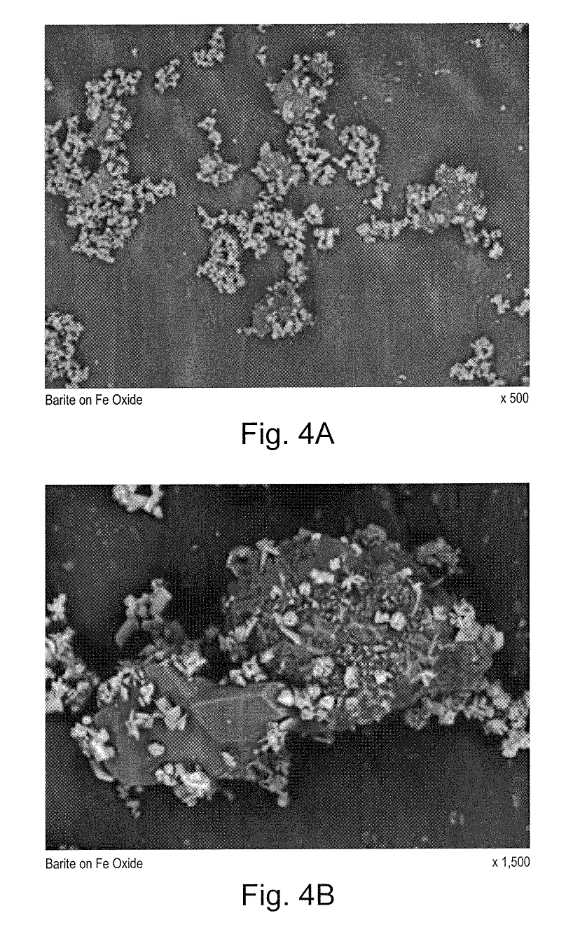

To 300 mL of deionized water, was added 100 g of hematite (Fe₂O₃). The solution was magnetically stirred at 700 rpm. The desired amount of Na₂SO₄ was added to the solution and soaked for 5 minutes until the salt was totally dissolved. Subsequently, BaCl₂ was added at 5 mL/min. The conditions (e.g. temperature and pH) can be controlled to obtain the desired BaSO₄ morphology. Barite crystals were then allowed to grow on iron oxide particles. The iron oxide particles were successfully coated with barite. SEM was employed to analyze the barite coated, iron oxide particles. A SEM image at 500 times magnification is shown in FIG. 4A, and a SEM image at 1,500 times magnification is shown in FIG. 4B.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of treating a subterranean formation, the method comprising:

placing in a subterranean formation a weighted composition comprising a coated weighting agent comprising
a weighting agent; and
an inorganic coating material on the weighting agent.

Embodiment 2 provides the method of Embodiment 1, wherein the weighted composition is a drilling fluid.

Embodiment 3 provides the method of any one of Embodiments 1-2, wherein the method further comprises obtaining or providing the weighted composition, wherein the obtaining or providing of the weighted composition occurs above-surface.

Embodiment 4 provides the method of any one of Embodiments 1-3, wherein the method further comprises obtaining or providing the weighted composition, wherein the obtaining or providing of the weighted composition occurs in the subterranean formation.

Embodiment 5 provides the method of any one of Embodiments 1-4, wherein the weighting agent is chosen from hard minerals, metal oxides, metal particles, and combinations thereof.

Embodiment 6 provides the method of any one of Embodiments 1-5, wherein the weighting agent is chosen from Al₂O₃, Al₂SiO₅, BiO₃, Bi₂O₃, CaSO₄, CaPO₄, CdS, Ce₂O₃, (Fe,Mg)Cr₂O₄, Cr₂O₃, CuO, Cu₂O, Cu₂(AsO₄)(OH), CuSiO₃.H₂O, Fe₃Al₂(SiO₄)₃, Fe²⁺Al₂O₄, Fe₂SiO₄, FeCO₃, Fe₂O₃, α-Fe₂O₃, α-FeO(OH), Fe₃O₄, FeTiO₃, (Fe,Mg)SiO₄, (Mn,Fe,Mg)(Al,Fe)₂O₄, CaFe²⁺₂Fe³⁺Si₂O₇O(OH), (YFe³⁺Fe²⁺U,Th, Ca)₂(Nb,Ta)₂O₈, MgO, Mn₂SiO₄, Mn(II)₃Al₂(SiO₄)₃, (Na_{0.3}Ca_{0.1}K_{0.1})(Mn⁴⁺,Mn³⁺)2O₄.1.5H₂O, (Mn,Fe)₂O₃, (Mn²⁺,Fe²⁺,Mg)(Fe³⁺,Mn³⁺)₂O₄, (Mn²⁺,Mn³⁺)₆[(O₈)(SiO₄)], Ca(Mn³⁺,Fe³⁺)₁₄SiO₂₄, Ba(Mn²⁺)(Mn⁴⁺)₈O₁₆(OH)₄, CaMoO₄, MoO₂, MoO₃, NbO₄, (Na,Ca)₂Nb₂O₆(OH,F), (Y,Ca,Ce,U,Th)(Nb,Ta,Ti)₂O₆, (Y,Ca,Ce,U,Th)(Ti,Nb,Ta)₂O₆, (Fe,Mn)(Ta,Nb)₂O₆, (Ce,La,Ca)BSiO₅, (Ce,La)CO₃F, (Y,Ce)CO₃F, MnO, MnO₂, Mn₂O₃, Mn₃O₄, Mn₂O₇, MnO(OH), (Mn²⁺,Mn³⁺)₂O₄, NiO, NiAs₂, NiAs, NiAsS, Ni₂Fe to Ni₃Fe, (Ni,Co)₃S₄, PbSiO₃, PbCO₃, (PbCl)₂CO₃, Pb²⁺2Pb⁴⁺O4, PbCu[(OH)₂(SO₄)], (Sb³⁺,Sb⁵⁺)O₄, Sb₂SnO₅, Sc₂O₃, SnO, SnO₂, Cu₂FeSnS₄, SrO, SrSO₄, SrCO₃, (Na,Ca)₂Ta₂O₆(O,OH,F), ThO₂, (Th,U)SiO₄, TiO₂, UO₂, V₂O₃, VO₂, V₂O₅, Pb₅(VO₄)₃Cl, VaO, Y₂O₃, ZnCO₃, ZnO, ZnFe₂O₄, ZnAl₂O₄, ZnCO₃, ZnO, ZrSiO₄, ZrO₂, ZrSiO₄, allemontite, altaite, aluminum oxide, anglesite, tin oxide, antimony trioxide, awaruite, barium sulfate, bastnaesite, beryllium oxide, birnessite, bismite, bismuth oxycarbonates, bismuth oxychloride, bismuth trioxide, bismuth (III) oxide, bixbyite, bournonite, braunite, brucite, cadimum sulfide, calayerite, calcium oxide, calcium carbonate, cassiterite, cerium oxide, cerussite, chromium oxide, clinoclase, columbite, copper, copper oxide, corundum, crocoite, cuprite, dolomite, euxenite, fergusonite, franklinite, gahnite, geothite, greenockite, hausmmanite, hematite, hercynite, hessite, ilvaite, Jacobsite, magnesium oxide, manganite, manganosite, magnetite, manganese dioxide, manganese (IV) oxide, manganese oxide, manganese tetraoxide, manganese (II) oxide, manganese (III) oxide, microlite, minium, molybdenum (IV) oxide, molybdenum oxide, molybdenum trioxide, nickel oxide, pearceite, phosgenite, psilomelane, pyrochlore, pyrolusite, rutile, scandium oxide, siderite, smithsonite, spessartite, stillwellite, stolzite, strontium oxide, tantalite, tenorite, tephroite, thorianite, thorite, tin dioxide, tin (II) oxide, titanium dioxide, vanadium oxide, vanadium trioxide, vanadium (IV) oxide, vanadium (V) oxide, witherite, wulfenite, yttrium oxide, zincite, zircon, zirconium oxide, zirconium silicate, zinc oxide, and combinations thereof.

Embodiment 7 provides the method of any one of Embodiments 1-6, wherein the weighting agent is chosen from iron, nickel, and combinations thereof.

Embodiment 8 provides the method of any one of Embodiments 1-7, wherein the inorganic coating material is a crystalline inorganic coating material.

Embodiment 9 provides the method of any one of Embodiments 1-8, wherein the crystalline inorganic coating material is chosen from calcium salts, barium salts, bismuth salts, aluminum salts, sodium salts, potassium salts, iron salts, nickel salts, cadmium salts, cesium salts, strontium salts, magnesium salts, zinc salts, lead salts, and mixtures thereof.

Embodiment 10 provides the method of any one of Embodiments 1-9, wherein the crystalline inorganic coating material is chosen from As₂S₃, BaCO₃, (BiO)₂CO₃, (Ca,Mg)CO₃, FeCO₃, PbCO₃, (PbCl)₂CO₃, PbCu(OH)₂(SO₄), Sb₂S₃, SnS, SnS₂, Sn₂S₃, SrSO₄, SrCO₃, ZnCO₃, ankerite, aluminum phosphate, aluminum sulfate, barium phosphate, barium sulfide, barium sulfate, beryllium sulfide, bismuth sulfide, calcium oxalate, calcium sulfide, calcium phosphate, calcium sulfate, calcium citrate, calcium carbonate, calcite, aragonite, manganese carbonate, gaspite, huntite, magnesite, nickel carbonate, strontium sulfide, thallium sulfide, and mixtures thereof.

Embodiment 11 provides the method of any one of Embodiments 1-10, wherein the inorganic coating material is an amorphous inorganic coating material.

Embodiment 12 provides the method of any one of Embodiments 1-11, wherein the amorphous inorganic coating material is chosen from phosphates, carbonates, silicates, tungstates, molybdates, aluminates, titanates, sulfides, oxides, hydroxides, silicates, silica, inorganic carbon compounds, and mixtures thereof.

Embodiment 13 provides the method of any one of Embodiments 1-12, wherein the amorphous inorganic coating material is chosen from As₂S₃, BaCO₃, (BiO)₂CO₃, (Ca,Mg)CO₃, FeCO₃, PbCO₃, (PbCl)₂CO₃, PbCu(OH)₂(SO₄), Sb₂S₃, SiO₂, SnS, SnS₂, Sn₂S₃, SrSO₄, SrCO₃, ZnCO₃, aluminum silicate, aluminum phosphate, aluminum sulfate, barium phosphate, barium sulfide, barium sulfate, bismuth sulfide, calcium oxalate, calcium silicate, calcium sulfide, calcium phosphate, calcium sulfate, calcium citrate, calcium tungstate, copper sulfide, graphite, iron sulfide, manganese carbonate, molybdenum disulfide, lithium iron(II) silicate, nickel carbonate, potassium silicate, strontium silicate aluminate, strontium sulfide, tungsten disulfide, zinc sulfide, zirconium(IV) silicate, and mixtures thereof.

Embodiment 14 provides the method of any one of Embodiments 1-13, wherein the coated weighting agent has a higher specific gravity than the inorganic coating material.

Embodiment 15 provides the method of any one of Embodiments 1-14, wherein the coated weighting agent has a lower specific gravity than the weighting agent.

Embodiment 16 provides the method of any one of Embodiments 1-15, wherein the weighting agent is at least partially acid soluble.

Embodiment 17 provides the method of any one of Embodiments 1-16, wherein the inorganic coating material is at least partially acid soluble.

Embodiment 18 provides the method of any one of Embodiments 1-17, wherein the coated weighting agent is at least partially acid soluble.

Embodiment 19 provides the method of any one of Embodiments 1-18, wherein the coated weighting agent has a particle size of about 0.1 μm to about 1,000 μm.

Embodiment 20 provides the method of any one of Embodiments 1-19, wherein the coated weighting agent has a particle size of at least about 0.1 μm.

Embodiment 21 provides the method of any one of Embodiments 1-20, wherein the coated weighting agent is less abrasive than a corresponding weighting agent that is free of the inorganic coating material.

Embodiment 22 provides the method of any one of Embodiments 1-21, wherein the coated weighting agent has a specific gravity of at least about 2.6.

Embodiment 23 provides the method of any one of Embodiments 1-22, wherein the coated weighting agent has a specific gravity of about 3 to about 20.

Embodiment 24 provides the method of any one of Embodiments 1-23, wherein the inorganic coating material is about 1 wt. % to about 50 wt. % of the coated weighting agent.

Embodiment 25 provides the method of any one of Embodiments 1-24, wherein the inorganic coating material is about 1 wt. % to about 10 wt. % of the coated weighting agent.

Embodiment 26 provides the method of any one of Embodiments 1-25, wherein the inorganic coating material coats about 10% to about 50% of the surface of the weighting agent.

Embodiment 27 provides the method of any one of Embodiments 1-26, wherein the inorganic coating material coats about 50% to about 100% of the surface of the weighting agent.

Embodiment 28 provides the method of any one of Embodiments 1-27, wherein the viscosity of the weighted composition is different than for a corresponding composition that is free of the coated weighting agent.

Embodiment 29 provides the method of any one of Embodiments 1-28, further comprising growing the crystalline inorganic coating material on the weighting agent.

Embodiment 30 provides the method of any one of Embodiments 1-29, wherein the coated weighting agent is made by a process of growing crystals of the crystalline inorganic coating material on the weighting agent.

Embodiment 31 provides the method of any one of Embodiments 1-30, further comprising combining the weighted composition with an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof, to form a mixture, wherein the placing the weighted composition in the subterranean formation comprises placing the mixture in the subterranean formation.

Embodiment 32 provides the method of any one of Embodiments 1-31, wherein the cementing fluid comprises Portland cement, pozzolana cement, gypsum cement, high alumina content cement, slag cement, silica cement, or a combination thereof.

Embodiment 33 provides the method of any one of Embodiments 1-32, wherein at least one of prior to, during, and after the placing of the weighted composition in the subterranean formation, the weighted composition is used in the subterranean formation, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof.

Embodiment 34 provides the method of any one of Embodiments 1-33, wherein the weighted composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, or a combination thereof.

Embodiment 35 provides the method of any one of Embodiments 1-34, wherein the placing of the weighted composition in the subterranean formation comprises fracturing at least part of the subterranean formation to form at least one subterranean fracture.

Embodiment 36 provides the method of any one of Embodiments 1-35, wherein the weighted composition further comprises a proppant, a resin-coated proppant, or a combination thereof.

Embodiment 37 provides the method of any one of Embodiments 1-36, wherein the placing of the weighted composition in the subterranean formation comprises pumping the weighted composition through a tubular disposed in a wellbore and into the subterranean formation.

Embodiment 38 provides the method of any one of Embodiments 1-37, wherein the placing of the weighted composition in the subterranean formation comprises pumping the weighted composition through a drill string disposed in a wellbore, through a drill bit at a downhole end of the drill string, and back above-surface through an annulus.

Embodiment 39 provides the method of any one of Embodiments 1-38, further comprising processing the weighted composition exiting the annulus with at least one fluid processing unit to generate a cleaned weighted composition and recirculating the cleaned weighted composition through the wellbore.

Embodiment 40 provides a system for performing the method of any one of Embodiments 1-39, the system comprising:

a tubular disposed in the subterranean formation; and

a pump configured to pump the weighted composition in the subterranean formation through the tubular.

Embodiment 41 provides a system for performing the method of any one of Embodiments 1-39, the system comprising:

a drill string disposed in a wellbore, the drill string comprising a drill bit at a downhole end of the drill string;

an annulus between the drill string and the wellbore; and

a pump configured to circulate the weighted composition through the drill string, through the drill bit, and back above-surface through the annulus.

Embodiment 42 provides a method of treating a subterranean formation, the method comprising:

placing in a subterranean formation a weighted composition comprising a coated weighting agent comprising:
iron oxide; and
a crystalline inorganic coating material on the iron oxide, wherein the crystalline inorganic coating material is chosen from barium sulfate, calcium carbonate, and combinations thereof.

Embodiment 43 provides a system comprising:

a weighted composition comprising a coated weighting agent comprising
a weighting agent; and
an inorganic coating material on the weighting agent, and

a subterranean formation comprising the weighted composition therein.

Embodiment 44 provides the system of Embodiments 43, further comprising

a drill string disposed in a wellbore, the drill string comprising a drill bit at a downhole end of the drill string;

an annulus between the drill string and the wellbore; and

a pump configured to circulate the weighted composition through the drill string, through the drill bit, and back above-surface through the annulus.

Embodiment 45 provides the system of any one of Embodiments 43-44, further comprising a fluid processing unit configured to process the weighted composition exiting the annulus to generate a cleaned drilling fluid for recirculation through the wellbore.

Embodiment 46 provides the system of any one of Embodiments 43-45, further comprising

a tubular disposed in the subterranean formation; and

a pump configured to pump the weighted composition in the subterranean formation through the tubular.

Embodiment 47 provides a weighted composition for treatment of a subterranean formation, the weighted composition comprising a coated weighting agent comprising:

a weighting agent; and

a crystalline inorganic coating material on the weighting agent.

Embodiment 48 provides the composition of Embodiment 47, wherein the weighted composition is a composition for drilling of a subterranean formation.

Embodiment 49 provides the composition of any one of Embodiments 47-48, wherein the weighted composition further comprises a downhole fluid.

Embodiment 50 provides a weighted composition for treatment of a subterranean formation, the weighted composition comprising a coated weighting agent comprising:

iron oxide; and

a crystalline inorganic coating material on the weighting agent, wherein the crystalline inorganic coating material is chosen from barium sulfate, calcium carbonate, and combinations thereof.

Embodiment 51 provides a method of preparing a weighted composition for treatment of a subterranean formation, the method comprising:

forming a weighted composition comprising a coated weighting agent comprising
a weighting agent; and
a crystalline inorganic coating material on the weighting agent.

Embodiment 52 provides for the method of Embodiment 51, wherein preparing the coated weighting agent comprises growing the crystalline inorganic coating material on the weighting agent.

Embodiment 53 provides for any one of Embodiments 51-52, wherein preparing the coated weighting agent comprises using the weighting agent to seed crystallization of the crystalline inorganic coating material.

Embodiment 54 provides for any one of Embodiments 51-53, wherein the crystalline inorganic coating material comprises a first ion and a corresponding second counterion.

Embodiment 55 provides for any one of Embodiments 51-54, wherein the growing the crystalline inorganic coating material on the weighting agent comprises:

adding the weighting agent to a solution comprising water;

adding a salt comprising the first ion of the crystalline inorganic coating material;

adding a solution comprising the second corresponding counterion; and

forming the crystalline inorganic coating material on the weighting agent.

What is claimed is:

1. A method of treating a subterranean formation, the method comprising:
placing in a subterranean formation a weighted composition comprising a coated weighting agent comprising
a weighting agent; and
an inorganic coating material on the weighting agent.

2.-5. (canceled)

6. The method of claim 1, wherein the weighting agent is chosen from Al₂O₃, Al₂SiO₅, BiO₃, Bi₂O₃, CaSO₄, CaPO₄, CdS, Ce₂O₃, (Fe,Mg)Cr₂O₄, Cr₂O₃, CuO, Cu₂O, Cu₂(AsO₄)(OH), CuSiO₃.H₂O, Fe₃Al₂(SiO₄)₃, Fe²⁺Al₂O₄, Fe₂SiO₄, FeCO₃, Fe₂O₃, α-Fe₂O₃, α-FeO(OH), Fe₃O₄, FeTiO₃, (Fe,Mg)SiO₄, (Mn,Fe,Mg)(Al,Fe)₂O₄, CaFe²⁺₂Fe³⁺Si₂O₇O(OH), (YFe³⁺Fe²⁺U,Th, Ca)₂(Nb,Ta)₂O₈, MgO, Mn₂SiO₄, Mn(II)₃Al₂(SiO₄)₃, (Na_{0.3}Ca_{0.1}K_{0.1})(Mn⁴⁺,Mn³⁺)₂O₄.1.5H₂O, (Mn,Fe)₂O₃, (Mn²⁺,Fe²⁺,Mg)(Fe³⁺,Mn³⁺)₂O₄, (Mn²⁺,Mn³⁺)₆[(O₈)(SiO₄)], Ca(Mn³⁺,Fe³⁺)₁₄SiO₂₄, Ba(Mn²⁺)(Mn⁴⁺)₈O₁₆(OH)₄, CaMoO₄, MoO₂, MoO₃, NbO₄, (Na,Ca)₂Nb₂O₆(OH,F), (Y,Ca,Ce,U,Th)(Nb,Ta,Ti)₂O₆, (Y,Ca,Ce,U,Th)(Ti,Nb,Ta)₂O₆, (Fe,Mn)(Ta,Nb)₂O₆, (Ce,La,Ca)BSiO₅, (Ce,La)CO₃F, (Y,Ce)CO₃F, MnO, MnO₂, Mn₂O₃, Mn₃O₄, Mn₂O₇, MnO(OH), (Mn²⁺,Mn³⁺)₂O₄, NiO, NiAs₂, NiAs, NiAsS, Ni₂Fe to Ni₃Fe, (Ni,Co)₃S₄, PbSiO₃, PbCO₃, (PbCl)₂CO₃, Pb²⁺2Pb⁴⁺O₄, PbCu[(OH)₂(SO₄)], (Sb³⁺,Sb⁵⁺)O₄, Sb₂SnO₅, Sc₂O₃, SnO, SnO₂, Cu₂FeSnS₄, SrO, SrSO₄, SrCO₃, (Na,Ca)₂Ta₂O₆(O,OH,F), ThO₂, (Th,U)SiO₄, TiO₂, UO₂, V₂O₃, VO₂, V₂O₅, Pb₅(VO₄)₃Cl, VaO, Y₂O₃, ZnCO₃, ZnO, ZnFe₂O₄, ZnAl₂O₄, ZnCO₃, ZnO, ZrSiO₄, ZrO₂, ZrSiO₄, allemontite, altaite, aluminum oxide, anglesite, tin oxide, antimony trioxide, awaruite, barium sulfate, bastnaesite, beryllium oxide, birnessite, bismite, bismuth oxycarbonates, bismuth oxychloride, bismuth trioxide, bismuth (III) oxide, bixbyite, bournonite, braunite, brucite, cadimum sulfide, calayerite, calcium oxide, calcium carbonate, cassiterite, cerium oxide, cerussite, chromium oxide, clinoclase, columbite, copper, copper oxide, corundum, crocoite, cuprite, dolomite, euxenite, fergusonite, franklinite, gahnite, geothite, greenockite, hausmmanite, hematite, hercynite, hessite, ilvaite, Jacobsite, magnesium oxide, manganite, manganosite, magnetite, manganese dioxide, manganese (IV) oxide, manganese oxide, manganese tetraoxide, manganese (II) oxide, manganese (III) oxide, microlite, minium, molybdenum (IV) oxide, molybdenum oxide, molybdenum trioxide, nickel oxide, pearceite, phosgenite, psilomelane, pyrochlore, pyrolusite, rutile, scandium oxide, siderite, smithsonite, spessartite, stillwellite, stolzite, strontium oxide, tantalite, tenorite, tephroite, thorianite, thorite, tin dioxide, tin (II) oxide, titanium dioxide, vanadium oxide, vanadium trioxide, vanadium (IV) oxide, vanadium (V) oxide, witherite, wulfenite, yttrium oxide, zincite, zircon, zirconium oxide, zirconium silicate, zinc oxide, and combinations thereof.

7.-9. (canceled)

10. The method of claim 1, wherein the crystalline inorganic coating material is chosen from As₂S₃, BaCO₃, (BiO)₂CO₃, (Ca,Mg)CO₃, FeCO₃, PbCO₃, (PbCl)₂CO₃, PbCu(OH)₂(SO₄), Sb₂S₃, SnS, SnS₂, Sn₂S₃, SrSO₄, SrCO₃, ZnCO₃, ankerite, aluminum phosphate, aluminum sulfate, barium phosphate, barium sulfide, barium sulfate, beryllium sulfide, bismuth sulfide, calcium oxalate, calcium sulfide, calcium phosphate, calcium sulfate, calcium citrate, calcium carbonate, calcite, aragonite, manganese carbonate, gaspite, huntite, magnesite, nickel carbonate, strontium sulfide, thallium sulfide, and mixtures thereof.

11. The method of claim 1, wherein the inorganic coating material is an amorphous inorganic coating material.

12. (canceled)

13. The method of claim 11, wherein the amorphous inorganic coating material is chosen from As₂S₃, BaCO₃, (BiO)₂CO₃, (Ca,Mg)CO₃, FeCO₃, PbCO₃, (PbCl)₂CO₃, PbCu(OH)₂(SO₄), Sb₂S₃, SiO₂, SnS, SnS₂, Sn₂S₃, SrSO₄, SrCO₃, ZnCO₃, aluminum silicate, aluminum phosphate, aluminum sulfate, barium phosphate, barium sulfide, barium sulfate, bismuth sulfide, calcium oxalate, calcium silicate, calcium sulfide, calcium phosphate, calcium sulfate, calcium citrate, calcium tungstate, copper sulfide, graphite, iron sulfide, manganese carbonate, molybdenum disulfide, lithium iron(II) silicate, nickel carbonate, potassium silicate, strontium silicate aluminate, strontium sulfide, tungsten disulfide, zinc sulfide, zirconium(IV) silicate, and mixtures thereof.

14.-19. (canceled)

20. The method of claim 1, wherein the coated weighting agent has a particle size of at least about 0.1 μm.

21. (canceled)

22. The method of claim 1, wherein the coated weighting agent has a specific gravity of at least about 2.6.

23. (canceled)

24. The method of claim 1, wherein the inorganic coating material is about 1 wt. % to about 50 wt. % of the coated weighting agent.

25.-30. (canceled)

31. The method of claim 1, further comprising combining the weighted composition with an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof, to form a mixture, wherein the placing the weighted composition in the subterranean formation comprises placing the mixture in the subterranean formation.

32. The method of claim 31, wherein the cementing fluid comprises Portland cement, pozzolana cement, gypsum cement, high alumina content cement, slag cement, silica cement, or a combination thereof.

33. The method of claim 1, wherein at least one of prior to, during, and after the placing of the weighted composition in the subterranean formation, the weighted composition is used in the subterranean formation, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof.

34. The method of claim 1, wherein the weighted composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, or a combination thereof.

35. The method of claim 1, wherein the placing of the weighted composition in the subterranean formation comprises fracturing at least part of the subterranean formation to form at least one subterranean fracture.

36. The method of claim 1, wherein the weighted composition further comprises a proppant, a resin-coated proppant, or a combination thereof.

37. (canceled)

38. The method of claim 1, wherein the placing of the weighted composition in the subterranean formation comprises pumping the weighted composition through a drill string disposed in a wellbore, through a drill bit at a downhole end of the drill string, and back above-surface through an annulus.

39. The method of claim 1, further comprising processing the weighted composition exiting the annulus with at least one fluid processing unit to generate a cleaned weighted composition and recirculating the cleaned weighted composition through the wellbore.

40. (canceled)

41. (canceled)

42. A method of treating a subterranean formation, the method comprising:
placing in a subterranean formation a weighted composition comprising a coated weighting agent comprising
iron oxide; and
a crystalline inorganic coating material on the iron oxide, wherein the crystalline inorganic coating material is chosen from barium sulfate, calcium carbonate, and combinations thereof.

43.-50. (canceled)

51. A method of preparing a weighted composition for treatment of a subterranean formation, the method comprising:
forming a weighted composition comprising a coated weighting agent comprising
a weighting agent; and
a crystalline inorganic coating material on the weighting agent.

52. The method of claim 51, wherein preparing the coated weighting agent comprises growing the crystalline inorganic coating material on the weighting agent.

53. The method of claim 51, wherein preparing the coated weighting agent comprises using the weighting agent to seed crystallization of the crystalline inorganic coating material.

54. (canceled)

55. (canceled)
